(19) United States
(12) Patent Application Publication
(10) Pub. No.: US 2020/0195907 A1
(43) Pub. Date: Jun. 18, 2020

(54) Method of adapting a three-dimension camera array for underground utilization

(71) Applicant: John Hubbard, Hampstead, NH (US)

(72) Inventor: John Hubbard, Hampstead, NH (US)

(21) Appl. No.: 16/717,573

(22) Filed: Dec. 17, 2019

Related U.S. Application Data
(60) Provisional application No. 62/780,607, filed on Dec. 17, 2018.

(51) Int. Cl. H04N 13/243; H04N 5/225; H04N 5/232; H04N 5/33

(52) U.S. Cl. CPC H04N 13/243; H04N 5/2258; H04N 5/33; H04N 5/23299; H04N 5/2252

(57) ABSTRACT

A system and method for rendering a 3D camera apparatus able to move and rotate as designed, in an upside-down configuration. The system allows for a user to control the camera via the system from above by lowering the camera and system into a manhole or septic tank, allowing a camera to take pictures from the lowest desired point all the way up to the top of the hole.

### CROSS REFERENCE TO RELATED APPLICATION

This application takes claims priority to and takes the benefit of U.S. Provisional Patent Application Ser. No. 62/780,607 filed on Dec. 17, 2018, the contents of which are herein incorporated by reference.

### BACKGROUND OF THE INVENTION

### Field of The Invention

The present invention relates generally to cameras and other such surveillance systems for taking measurements in confined regions or spaces such as manholes and septic tanks, and, more particularly, to a system and apparatus for lowering and guiding instruments such 3-D camera apparatuses and the like taking advanced pictures and measurements of a manhole and the like.

### Description of the Related Art

Urban and suburban utility systems, such as septic, sewage and lighting systems, normally utilize a network vertical and horizontal tubes located beneath city and town streets. Most of these may be accessed by cylindrical fixtures, normally called manholes. Additionally, it behooves public works officials and departments to have access to accurate date, including pictures, relating to location, condition and other information related to manholes. One example important information is that it is crucial to know the dimensions and layout of each manhole in order to plan the re-lining of sewers or other renovation work.

This type of information is not always readily available or easily attainable. In many locations, the manholes were installed over many years, with several years in between, often using differing methods and often with little or no records being kept concerning their location or layout. Even today, record keeping is not at its best, sometimes non-existent.

In order to create a solution to this issue, many municipalities have decided to map their sewer systems including details related to manholes and inverts. This is a large project since each municipality can have thousands of manholes and inverts making precision and cost causes for concern. Since no specific tool or system has been developed to tackle this task, readings are inaccurate and cost is high as more expensive equipment is being used to supplement. The equipment is hard to use, often requiring more than one person. Once measurements have been taken, there is yet still room for error, as the next step requires sketching the manhole and transferring the date to an electronic database. Many times, the information is so inaccurate that it cannot be relied upon and a second reading must take place wasting more time and money.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses relating to camera accessories and fixtures, apparatuses to greater facilitate camera systems to operate under challenging conditions are illustrated. Thus, the several embodiments of the instant apparatus are illustrated herein.

It is therefore an objective of the instant system to introduce a novel system or platform for a camera system.

It is therefore an objective of the instant system to introduce novel system or platform for a 3D Camera system.

It is therefore an objective of the instant system to introduce a novel system or platform for a Matterport® Pro 3D Camera system.

It is therefore an objective of the instant system to introduce a novel platform for a 3D Camera which does not inhibit picture integrity.

It is therefore an objective of the instant system introduce a novel platform for a 3D Camera which allows the 3D camera to rotate.

It is therefore an objective of the instant system to introduce a novel platform for a 3D Camera, in one embodiment the system by way of a three-sided receptacle that supports the 3D Camera by sliding the camera into the side of the cage.

It is therefore an objective of the instant system to introduce a novel platform for a 3D Camera which supports the camera from above and allows for free motor rotation.

It is therefore an objective of the instant system to introduce novel bearing system for a 3D Camera platform which allows for free motor rotation.

It is therefore an objective of the instant system to introduce a novel bearing system for 3D Camera platform which attaches by screw assembly to the base of the camera.

It is therefore an objective of the instant system to introduce a novel bearing system for a Matterport® Pro, to be able to function when supported from above, instead of its usual design constraint of being supported from below as on a tripod mount.

It is therefore an objective of the instant system to introduce a novel bearing system for a 3D Camera platform which attaches a metal or plastic plate to the top or the camera where it is fitted with a ball bearing assembly which is in turn coupled to the end of a pole or series of poles allowing free rotation provided by the 3D camera's own internal motor.

It is therefore an objective of the instant system to introduce a novel bearing system for a 3D Camera platform which uses tension or clamps to secure the cage bars to the base plate to prevent the 3D camera from slipping out of place.

It is therefore an objective of the instant system introduce a novel bearing system with cage bars that are flexible.

It is therefore an objective of the instant system to introduce a novel bearing system with a metal strut to keep the base place from rotating, allowing the 3D camera to function normally.

It is therefore an objective of the instant system to introduce a novel bearing system to allow a 3D camera to scan the insside of a manhole from the lowest desired point in the hole up to the surface.

It is also an additional object of the instant system to have a novel bearing system that is inexpensive, portable, precise and easy to use.

These together, with the other objectives of the device, along with the various features of novelty, which characterize the apparatus, are pointed out with particularity in the claims annexed to and forming a part of this disclosure. For a better understanding of the mechanism, its operating advantages, and the specific objectives attained by its use, study of the accompanying drawings and descriptive matter, in which there are illustrations of the preferred embodiments, should be conducted.

There has thus been outlined, rather broadly, the more important features of the versatile integrated Instant System, and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an inside perspective view of one embodiment of the instant system's plastic casing, deemed Gibbet Mount apparatus version one (1), including the six cameras within the apparatus and the outside casing including three bowed retaining arms or cage bars further illustrating one version of a bottom mount plate and first a rotating joining of the present apparatus.

FIG. 2 illustrates the embodiment of the instant system, deemed Gibbet Mount apparatus version (2), including a close look at the camera array which may include six (6) cameras within the system and infrared sensors on the left of the camera array, and a rotating joining of the present apparatus.

FIG. 3 illustrates embodiment of the instant system within the plastic encasing focusing on the C-Clips that hold secure the metal rods that support the camera array.

FIG. 4 illustrates an embodiment of the side view of the present apparatus.

FIG. 5 illustrates an embodiment of the C-Clips removed from the apparatus and the metal rods released from the device, freeing the camera array from its mount.

FIG. 6 illustrates an embodiment the camera array loose from its mount and any connections.

FIG. 7 illustrates an embodiment of the instant system carefully rotated 180° so that the top and bottom of the device are reversed.

FIG. 8 illustrates an embodiment if the stepper motor next to the battery within the apparatus.

FIG. 9 illustrates an embodiment of the disconnected four (4) wire connectors, which are red, blue, green, and black from left to right, from the stepper motor to the circuit board.

FIG. 10 illustrates an embodiment of the wiring described in FIG. 9 placed in reverse wire ordering, and back in their clip, in the order of black, green, blue and red from left to right.

FIG. 11 illustrates an embodiment of the polarity reversed and the direction of the camera rotating counter-clockwise from left to right.

FIG. 12 illustrates an embodiment of a reassembled apparatus with the metal rods replaced into the device, so now the cameras are on the left side of the apparatus and the camera will collect data upside down and will spin in the correct direction for the pie shaped capture in order. The embodiment shows the camera upside down, for capturing places in man-holes, will produce a model that is upside right.

### DETAILED DESCRIPTION OF THE SEVERAL EMBODIMENTS

The detailed description set forth below is intended as a description of presently preferred embodiments of the invention and does not represent the only forms in which the instant invention may be construed and/or utilized. However, it is to be understood that the same or equivalent functions may be accomplished by different embodiments and are also intended to be encompassed within the scope of the invention.

The system is designed to uniquely satisfy three (3) critical criteria as an apparatus for lowering and guiding 3D cameras, that includes being wholly portable, easy to use, and simultaneously inexpensive. First, the camera apparatus is designed to be portable in order to allow the unit to be transferred to a specific location as it relates to satisfying a unique need within that environment in a timely and cost-efficient manner. Of great importance here, the camera apparatus can be specific and customized into an environment; hence, the camera apparatus is a practical and efficient means to save time and ultimately costs.

Second the camera apparatus is designed to be easy to use in numerous embodiments, including a portable embodiment for users to carry with them.

Third, the camera apparatus is designed to be inexpensive. The apparatus comprises one piece comprised of multiple parts. The apparatus is comprised of inexpensive materials.

In the instant system, the top may possess varying intended shapes, angles and sizes, relative to the desired size for transport and size of the manhole.

Within the several differing embodiments illustrated graphically and discussed within the descriptive matter herein, some embodiments include systems wherein the camera is encased only by intersection of members above and below the camera. Still, other embodiments will illustrate a more intricate structure wherein the camera is almost completely encased by a containment vessel.

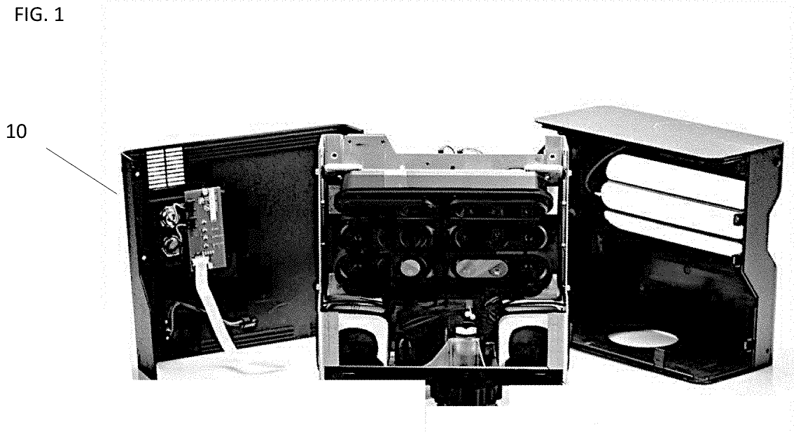

FIG. 1 illustrates an inside prospective of the device. Panel 10 displays the inside of the device when the screws are removed, releasing the plastic casing of the device, disconnecting the antenna and power control electric, showing the inside of the machine.

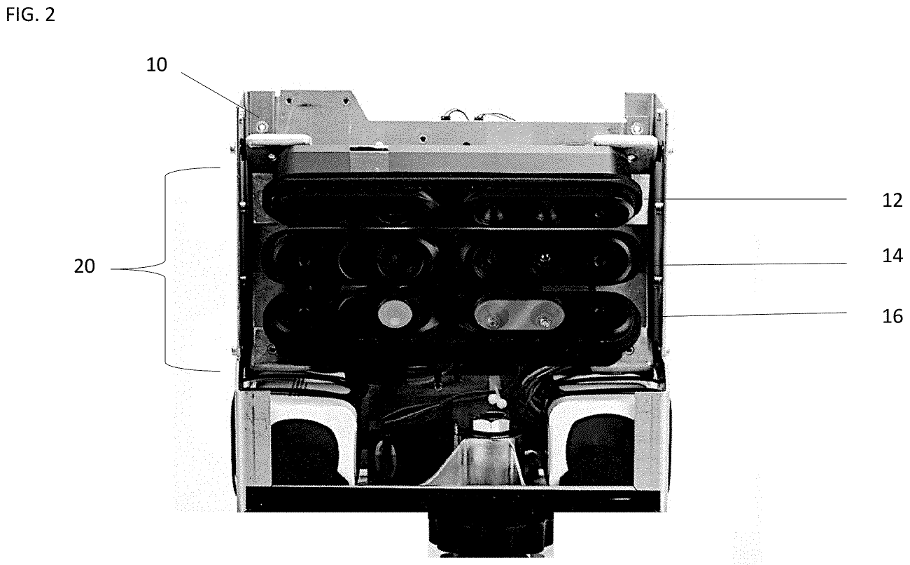

FIG. 2 illustrates the main body of the machine within the plastic casing. There are infrared sensors on the left of the camera as displayed in panel 10 and the camera array 20, which may include, but is not limited to, six camera lens sets, displayed in individual strip panels 12, 14, and 16.

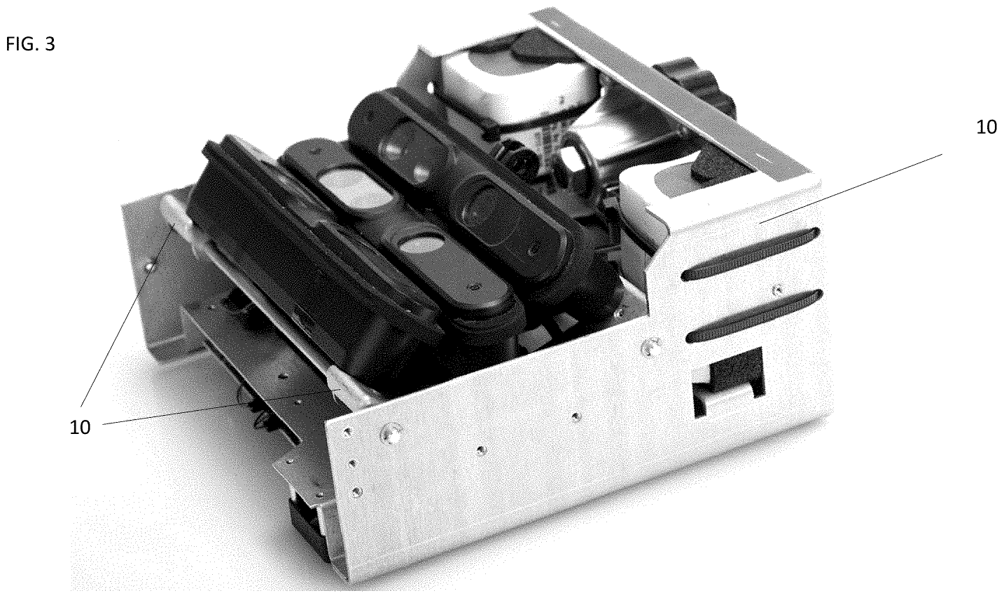

FIG. 3 illustrates the C-Clips 25 that hold secure the metal rods that support the camera array as displayed in panel 10.

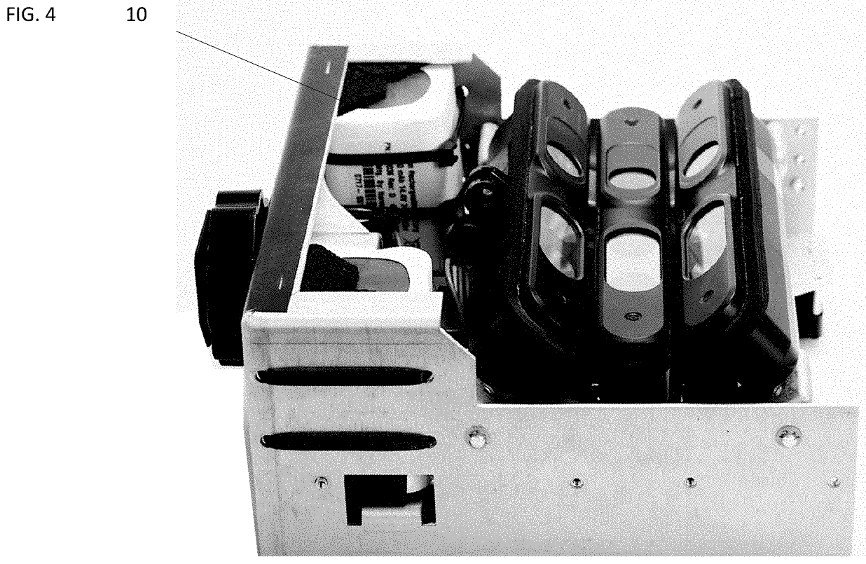

FIG. 4 illustrates a side view of the C-Clips that hold secure the metal rods that support the camera as displays in panel 10.

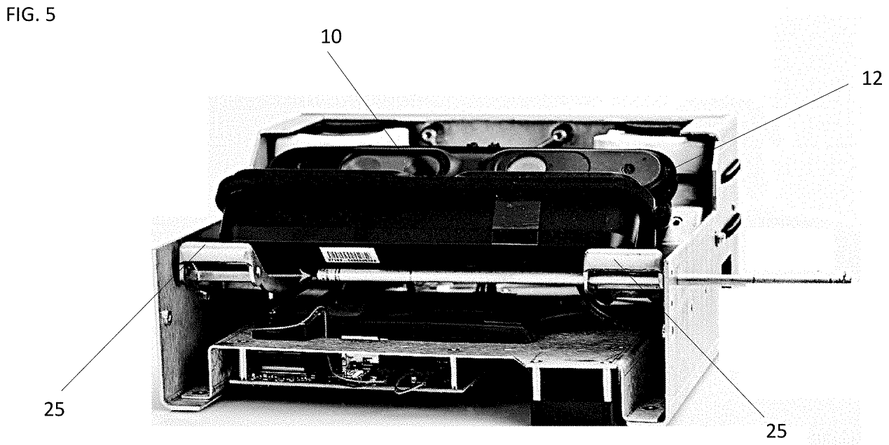

FIG. 5 illustrates the camera array freed from its mount, as shown in panel 10, due to a release of the C-Clips and the support rods being pulled out, shown in panel 12.

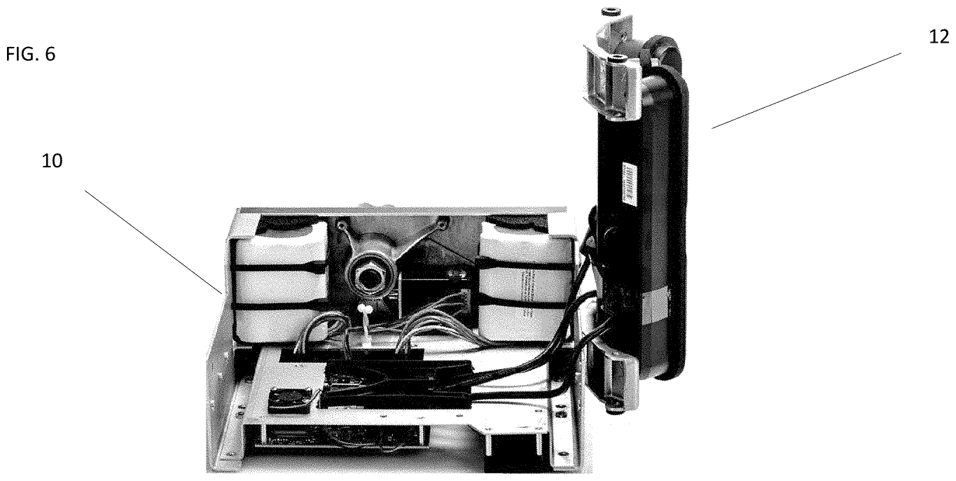

FIG. 6 illustrates the camera array, panel 10, loose from its mount connections, panel 12.

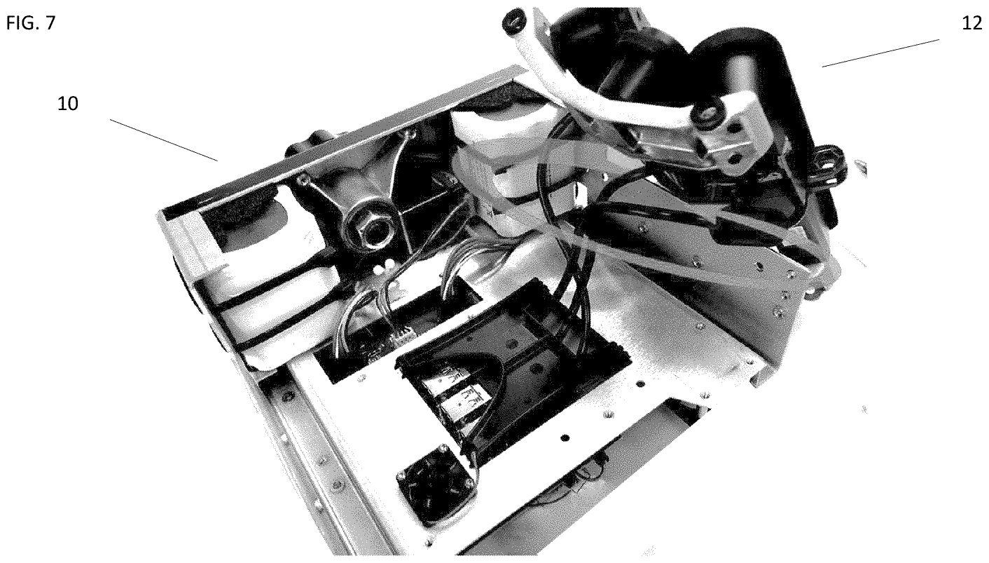

FIG. 7 illustrates the camera array turned at 180°, panel 10, so that the top and bottom are reversed, panel 12.

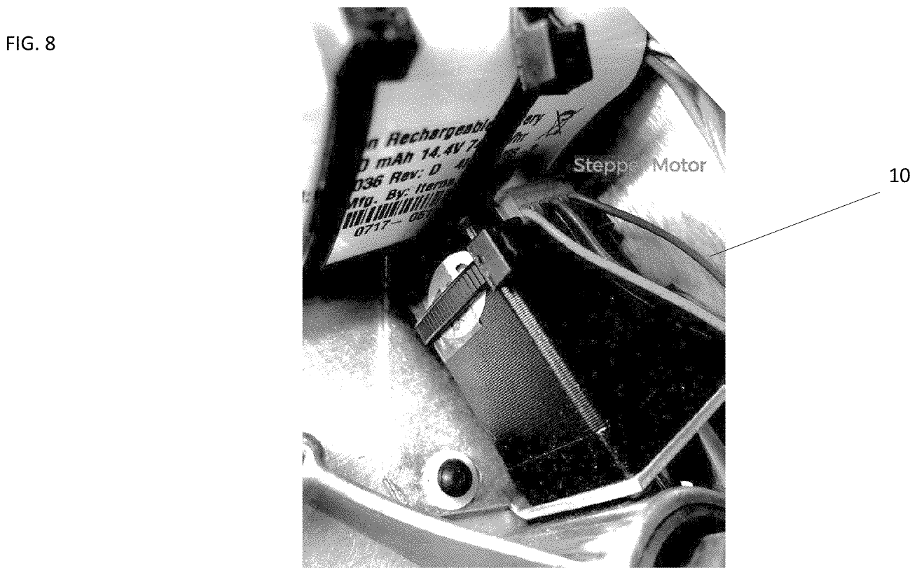

FIG. 8 illustrates the stepper motor next to the battery, shown in panel 10.

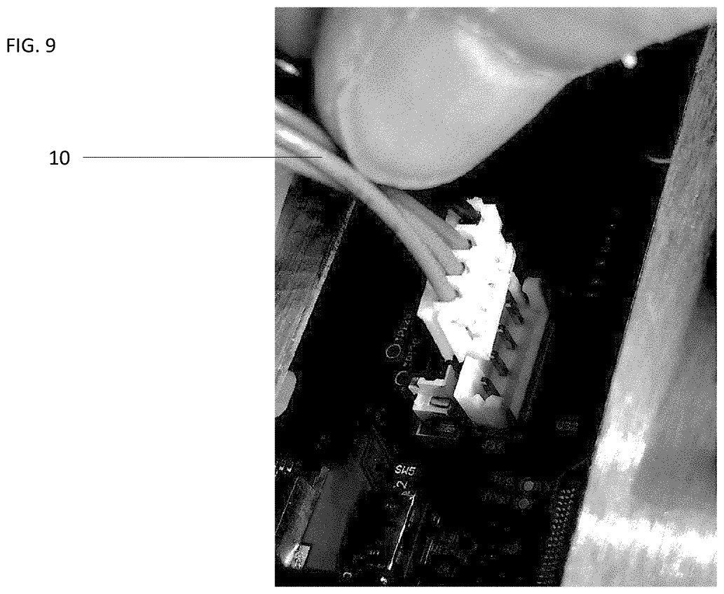

FIG. 9 illustrates a disconnected 4 wire connector from the stepper motor to the circuit board, shown in panel 10. The coloring of the wires in panel 10 are red, blue, green, and black from left to right.

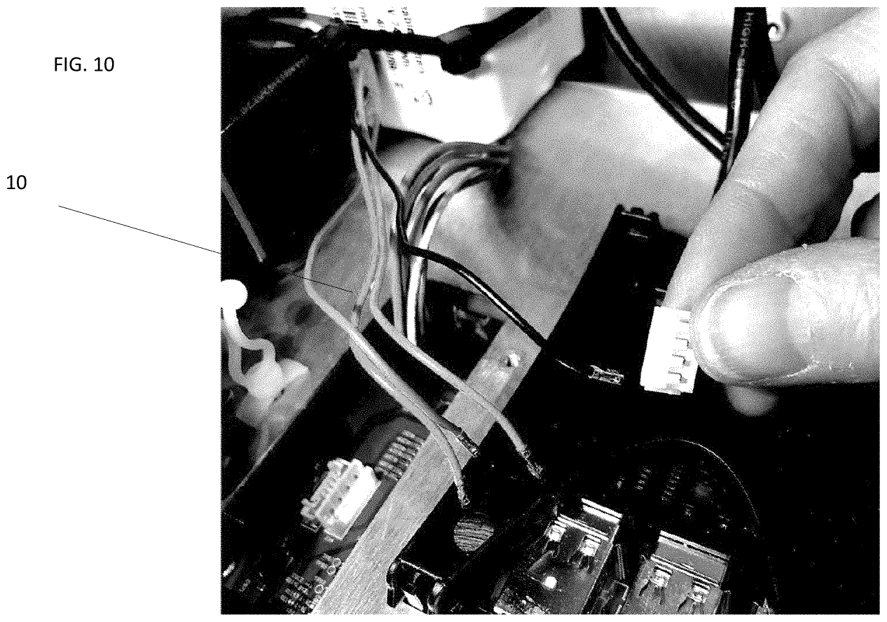

FIG. 10 illustrates the reverse wiring order, shown in FIG. 9, replacing them in their clip as black, green, blue, and red, shown in panel 10.

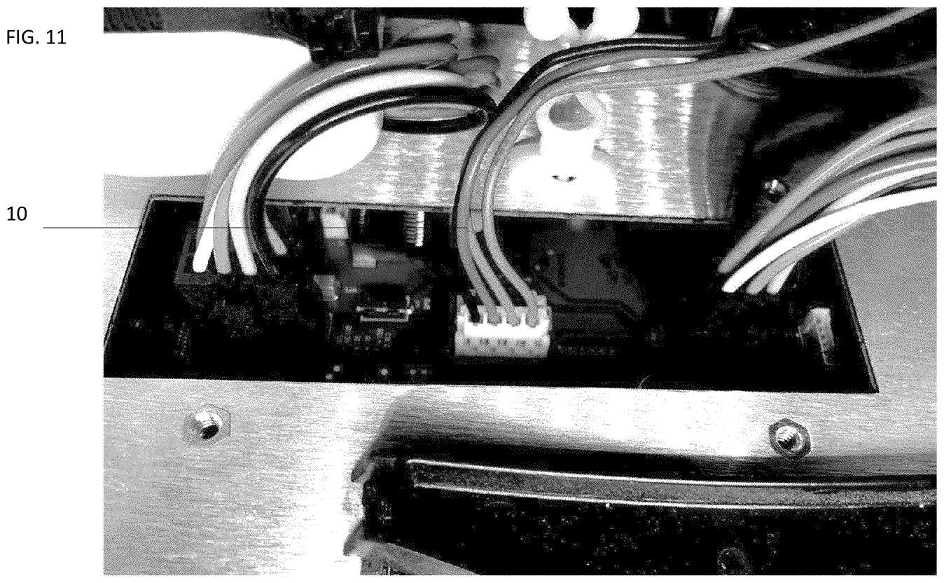

FIG. 11 illustrates when the colored wiring is reversed, as described in FIG. 10, reverses the polarity and direction of the camera to counter-clockwise from left to right, shown in panel 10.

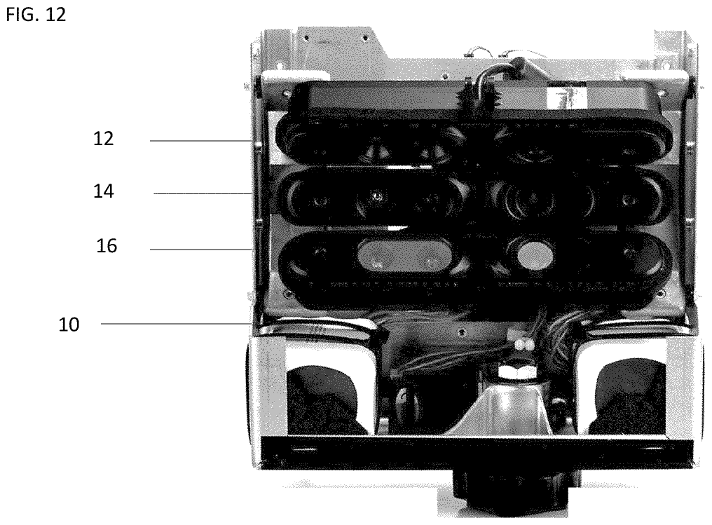

FIG. 12 illustrates the metal rod is replaced and the camera is reassembled, in panel 10. The six camera lenses are now on the left side and the camera will collect data upside down and will spin in the correct direction for the pie shaped capture order, shown in panels 12, 14, and 16. Mounting the camera upside down (for capturing places such as man-holes) will produce a model that is upside right.

In a preferred embodiment, a method of adapting a three-dimension camera array for underground utilization is disclosed which involves the steps of first:

removing the retaining screws and pulling carefully apart the plastic housing; disconnecting the antenna and power control electrical connections and ensuring that the infrared sensors are located on the left of camera array and six camera lenses are on the right side;

locating the C-Clips that hold that secure the metal rods that support the camera array;

removing the C-Clips and pull support rods out, freeing the camera array from the mount and with the camera array loose from its mount connections, rotate camera array 180° so that the top and bottom are reversed;

locating the stepper motor next to the battery and disconnecting the four wire connectors from the stepper motor to the circuit board;

noting that the wiring is red, blue, green, black from left to right;

reversing the wiring order, replacing them in their clip as black, green, blue, red and thus reversing the polarity and direction of camera rotation to counter-clockwise from left to right; and

replacing the metal rods, reassemble the camera wherein the six camera lenses are now on the left and the camera will collect data upside down and will spin in the correct direction for the pie shaped capture in order.

In an additional embodiment for designed for lowering the apparatus to subterranean regions, a tripod assembly which remains located at the surface, may be utilized. The tripod may be modified in order to allow a shaft to pass through and the tripod may be equipped with the ability to secure the shaft tightly. The instant camera delivery system prior to entering and deep within a subterranean environment, such as a manhole for sewer, telecom date or the like. Such environments are notorious for hazardous conditions, including but not limited to noxious gases, pest issues, electrocution danger and contaminated water conditions. These are some of the many dangers faced by technicians looking to gather data in these environs such as subterranean regions and the system when embarked in these environs produces a visual 3-D model which is measureable and viewable from any desktop or handheld device. The system also produces a Point Cloud for AutoCad® which is an extremely valuable and possibly life-saving tool as the instant system allows a technician to collect very effective data without ever breaching a manhole surface. Prior to the introduction of the instant system, 3-D cameras could only be utilized in above surface forums.

Prior to the introduction of the instant system to deliver 3-D cameras to these areas, the only options for a person looking to inspect such places was with a Laser scanner (which would only produce a point cloud of mathematical data, would not provide visual inspection and would not be cost effect as this could cost greater than $40,000) or with a “pole” camera which would be affixed to a stick and could not be integrated for measurement.

In an additional embodiment, a system which is designed to be deployed via an embarked vehicle is conceptualized. In said embodiment, a system deemed as the SubCam™ trailer hitch mounting provides the user the ability to launch and operate the instant system directly from a vehicle, which affords the user the ability to operate in shelter during inclement weather.

What is claimed is:

1. A method of adapting a three-dimension camera array for underground utilization comprising the steps of:
removing the retaining screws and pulling carefully apart the plastic housing; disconnecting the antenna and power control electrical connections and ensuring that the infrared sensors are located on the left of camera array and six camera lenses are on the right side;
locating the C-Clips that hold that secure the metal rods that support the camera array;
removing the C-Clips and pull support rods out, freeing the camera array from the mount and with the camera array loose from its mount connections, rotate camera array 180° so that the top and bottom are reversed;
locating the stepper motor next to the battery and disconnecting the four wire connectors from the stepper motor to the circuit board;
noting that the wiring is red, blue, green, black from left to right;
reversing the wiring order, replacing them in their clip as black, green, blue, red and thus reversing the polarity and direction of camera rotation to counter-clockwise from left to right; and
replacing the metal rods, reassemble the camera wherein the six camera lenses are now on the left and the camera will collect data upside down and will spin in the correct direction for the pie shaped capture in order.
